(19) United States
(12) Patent Application Publication
(10) Pub. No.: US 2001/0034679 A1
(43) Pub. Date: Oct. 25, 2001

(54) Platform independent and non-invasive financial report mark-up

(76) Inventor: Mark L. Wrigley, Great Falls, VA (US)

Correspondence Address: AKIN GUMP STRAUSS HAUER & FELD, 1900 FROST BANK PLAZA, 816 CONGRESS AVENUE, AUSTIN, TX, 78701

(21) Appl. No.: 09/760,543

(22) Filed: Jan. 16, 2001

Related U.S. Application Data
(60) Provisional application No. 60/177,333, filed on Jan. 21, 2000.
(60) Provisional application No. 60/242,510, filed on Oct. 23, 2000.

(51) Int. Cl. G06F 17/60

(52) U.S. Cl. 705/35; 707/1

(57) ABSTRACT

Platform independent and non-invasive financial report mark-up. The invention provides an enterprise-scale, non-invasive report mark-up system that gives substantially non-invasive approach to applications, processes and existing databases of the legacy system environment. The invention is operable to allow transition from the legacy system environment using one currency to another currency such as to the EURO over time. The invention allows for a number of operations without manual restatement, reconciliation or use of parallel systems; it also provides for access to timely information and electronic reporting of financial documents with substantial cost savings, thereby meeting the rapid response requirements necessitated by the continued emergence of e-commerce activities. A middleware layer that interfaces two layers that may be viewed as a legacy system environment and a client environment, such as a browser based Internet or other user environment, without the need for significant custom interface code between unique applications or environments.

### CROSS REFERENCE TO RELATED APPLICATIONS

The present application is based on and claims priority to U.S. Provisional Patent Application Ser. No. 60/177,333 entitled “SYSTEM AND METHOD FOR IMPLEMENTING EURO TRANSITION REQUIREMENTS,” (Attorney Docket No. PR1036), filed Jan. 21, 2000.

The present application is also based on and claims priority to U.S. Provisional Patent Application Ser. No. 60/242,510 entitled “PLATFORM INDEPENDENT AND NON-INVASIVE REPORT MARK-UP,” (Attorney Docket No. 00R2E101P), filed Oct. 23, 2000.

All of such applications are hereby incorporated herein by reference in their entirety, including any drawings and appendices, and is made part of the present U.S. Patent Application for all purposes.

### BACKGROUND

1. Technical Field

The present invention relates generally to report mark-up; and, more particularly, it relates to platform independent and non-invasive financial report mark-up.

2. Related Art

Twelve European countries are currently in transition from National Currency Units (NCU) to a single European currency, the EURO. There is great difficulty in converting to the EURO, and from an enterprise perspective the impacts to information technology (IT) systems are significant. One of the difficulties stems from the fact that the temporary transition phase requirements of the legacy currency (NCU) must co-exist with the new EURO during a certain period of time. There is no simple or easy overnight conversion from one currency to another under the currently proposed transitions schemes, and enterprises must deal with the problem of how to get useful information for users and systems that will enable them to operate in the new currency going forward.

During the transition period, which lasts from Dec. 1, 1999 to Jun. 30, 2002, the European Union has mandated numerous technical requirements relating to triangulation, permissible rounding errors, auditability, introduction of six significant digits, decimalization and other items which control the process but which cause very significant impacts to IT systems. It is the temporary requirements of transition that add most of the costs, and consultants have claimed that in many cases EURO IT impacts will exceed the scope of Y2K. When all this work has been accomplished, business will continue as before except that it will operate in EURO. No lasting competitive advantage will have been conferred.

Traditional approaches to solve this problem are in fact similar to Y2K, and most of them involve renovation of databases, which is a process that is highly invasive to the legacy system environment. Renovation converts the contents of the legacy databases from one currency to another, typically requiring field expansion and dealing with hard-coded entries and tables. Inevitably, unintended conversion errors will be introduced, and the change of currencies also impacts the audit trail since source documentation no longer matches the database. The effectiveness of techniques like scanning that improve productivity are limited by hard coding of fields and tables and other problems in the original code, since it was not designed to accommodate such changes. Further, if historical data must be converted manually in the databases, then a separate parallel system of historical data must be maintained for archiving purposes.

Large enterprises may have 200 or more legacy systems that are impacted by the change to a single European currency. The approach universally used is to apply a “wrapper” to the application or database, then to “renovate” the underlying database, and to do this uniquely to each and every system. The limitations of such a strategy are many in number. Examples of such limitations include the following: such changes are highly invasive to the legacy systems and introduce inevitable errors; legacy audit documentation no longer matches the converted currency; time to plan and execute are lengthy; and cost and resource availability can be prohibitive. Further, this work adds no lasting business value for the time and effort invested.

All of the conventional, proposed solutions work to fix a temporary problem, so that most of this functionality which is implemented on virtually every enterprise system that deals with financial data will be turned off or “thrown away” at the end of the co-existence or transition period between the national currencies and the EURO. Obviously, implementing these solutions on a system by system basis is extremely costly, risky, and time consuming, and adds dependence upon expensive outside contractors.

Further limitations and disadvantages of conventional and traditional systems will become apparent to one of skill in the art through comparison of such systems with the present invention as set forth in the remainder of the present application with reference to the drawings.

### SUMMARY OF THE INVENTION

Various aspects of the present invention can be found in an enterprise-scale non-invasive financial report mark-up processing system. The system includes a legacy system that is operable to generate structured legacy system information having a format and having financial data corresponding to a first currency standard and a middle-ware application layer, communicatively coupled to the legacy system, that is operable to receive the legacy system report from the legacy system via electronic printing thereby generating a legacy system e-report. The middle-ware application layer employs a profile to perform mark-up processing on selected portions of the legacy system e-report to generate a modified legacy system e-report, and the modified source e-report comprising financial data corresponding to a second currency standard.

In certain embodiments of the invention, the second currency standard includes a EURO currency. The middle-ware application layer may also include a burster, and the burster may also include the profile. The burster is operable to parse the legacy system e-report a number of sub-e-reports or a number of sub-portions. The at least one additional legacy system is operable to generate at least one additional legacy system report having at least one additional format and having financial data corresponding to a third currency standard. The middle-ware application layer is also communicatively coupled to the at least one additional legacy system and is operable to receive the at least one additional legacy system report from the at least one additional legacy system via electronic printing thereby generating at least one additional legacy system e-report. The middle-ware application layer employs at least one additional profile to perform mark-up processing on selected portions of the at least one additional legacy system e-report to generate at least one additional modified legacy system e-report. The modified source e-report includes financial data corresponding to a fourth currency standard. The profile and the at least one additional profile are substantially a common profile. The second currency standard and the fourth currency standard both include a common currency standard. The modified legacy system e-report is generated during a predetermined transition period from the first currency standard to the second currency standard.

Other aspects of the present invention can be found in an enterprise-scale non-invasive financial report mark-up processing system. The system includes a legacy system that is operable to generate a source report having financial information based on a national currency, a middle-ware application layer, communicatively coupled to the legacy system, that is operable to receive an electronically printed version of the source report and perform non-invasive mark-up processing of the financial information based on the national currency within the source report and to convert that financial information to financial information based on the EURO thereby generating a target report, and a user system, communicatively coupled to the middle-ware application layer, that is operable to retrieve the target report from the middle-ware application layer.

In certain embodiments of the invention, the at least one of the communicative coupling between the legacy system and the middle-ware application layer and the communicative coupling between the middle-ware application layer and the user system includes communicative coupling via the Internet. Other communicatively coupling, including intranet and extranet delivery are also included. The electronically printed version of the source report is generated based on an e-print profile. The non-invasive mark-up processing is performed using a profile having a number of processing rules, and the profile is contained within the middle-ware application layer. The middle-ware application layer distributes the target to at least one additional user system. The middle-ware application layer distributes the target to the user system after the user system transmits a request to the middle-ware application layer. The middle-ware application layer may also include a burster, and the burster may also include a profile.

Yet even other aspects of the present invention can be found in a method to perform non-invasive financial report mark-up processing. The method includes creating a source report profile to be used to process a source report where the source report includes financial data corresponding to a first currency standard, electronically transmitting the source report to a middle-ware application layer, processing the source report within the middle-ware application layer to generate a target report based on the report profile, and generating a modified source report where the modified source report includes financial data corresponding to a second currency standard.

In certain embodiments of the invention, the second currency standard includes a EURO currency. The target report is generated in response to a request provided by a user system. The target report includes a number of sub-portions. The target report may also be parsed into a number of sub-e-reports.

Other aspects, advantages and novel features of the present invention will become apparent from the following detailed description of the invention when considered in conjunction with the accompanying drawings.

### BRIEF DESCRIPTION OF THE DRAWINGS

A better understanding of the present invention can be obtained when the following detailed description of various exemplary embodiments is considered in conjunction with the following drawings.

FIG. 1 is a system diagram of an enterprise-scale, non-invasive report mark-up system built in accordance with the present invention.

FIG. 2 is a functional block diagram illustrating an embodiment of a method performed in accordance with the present invention.

FIG. 3 is a system diagram illustrating an embodiment of report processing performed in accordance with the present invention.

FIG. 4 is a system diagram illustrating another embodiment of report processing performed in accordance with the present invention.

FIG. 5 is a system diagram illustrating an embodiment of profile processing performed in accordance with the present invention.

FIG. 6 is a system diagram illustrating another embodiment of profile processing performed in accordance with the present invention.

FIG. 7 is a system diagram illustrating another embodiment of profile processing performed in accordance with the present invention.

FIG. 8 is a timeline diagram illustrating an embodiment of currency conversion that is capable to be performed in accordance with the present invention.

### DETAILED DESCRIPTION OF THE INVENTION

The current and future transition efforts of European nations to convert to the EURO offer an opportunity to apply emerging reporting technologies to this problem as a new paradigm in an unconventional manner not yet been seen in the marketplace after two years of transition.

In the existing emerging report technologies, an alternative does not exist that can operate at an enterprise scale to quickly implement this change in a flexible, fast, and scalable manner at lower cost while leaving behind a platform that is operable to add business value in the future.

The present invention is operable to provide an alternative to the use of wrappers and database renovation that are widely used in Europe to implement the transition to the EURO currency. By so doing, it is possible to substantially reduce the time and cost associated with historical data usage after EURO becomes the single currency, while adding business value in the form of retained information technology infrastructure that acts as a platform to provide instant e- access to enterprise information.

One critical choice that many enterprises face is whether to convert historical data using expensive techniques, or to leverage that data in a non-invasive way that cost effectively and quickly provides converted information to anyone in the information who has a need to know, at any time, anywhere. Until now, enterprises have performed this historical database renovation as an assumed part of the EURO conversion effort. This effort has three distinct parts in reality. They include 1) a transition, where the enterprise appears to the outside world to be operating in EURO; 2) a conversion, where the enterprise converts historical data in the databases to EURO; and 3) a migration, where all data entering the database in entered in EURO going forward. Tradition has held all three must occur as a big bang. Using certain aspects of the present invention, the historical data conversion can also be handled using the present invention, thereby obtaining some of the benefits outlined in this patent application.

The present invention provides a solution that contains a number of characteristics, some of which are enumerated below.

Non-invasive. The present invention is non-invasive to legacy databases to avoid the effort to restate and reconcile the entries and preclude creation of coding errors. The legacy environment is left in tact. This provides other advantages in terms of efficiency. The use of business rules allows for different currencies to co-exist in a single database without pollution.

Platform independent. Many environments of large enterprises have literally hundreds of systems. Solutions are hardware and software platform independent to speed rollout and add scalability to the solution.

Maintain auditability. The present invention is operable to maintain the audit trail by leaving the legacy financial data in the same currency as paper documentation. Indeed, any changes or conversions outside the legacy environment are contained in an audit log.

Enterprise scale. Changes outside the legacy systems are centrally managed on an enterprise scale. The present invention supports rollout to one system or many.

Improved Speed, Flexibility and Control. The present invention is inherently more flexible to accommodate change quickly across the enterprise, which may have literally hundreds of systems. It has inherent advantages of improved control and can be implemented with great speed. Implementation can literally be reduced from many months to weeks, using trained internal resources, at substantial savings.

Support for Interoperability. Such a solution is required to support the interoperability of solutions where some may have been updated by vendors and may require converted input from systems that are updated using this invention.

Phased Implementation. Some systems may have been updated by vendors, or systems or clusters of related systems may be upgraded at different times. This process is called a phased implementation and allows interoperability for transformed data to be shared across the enterprise in a productive and efficient manner.

Reduce Archiving and Storage. The present invention is operable to reduce the storage and archiving needed to deal with a converted and unconverted databases. Indeed, the solution itself may be viewed as actually being the archive solution for converted data.

Rounding Error Detection and Correction. The present invention is operable to detect and correct the occurrence of rounding errors permitted and inevitable under the regulations;

Reduced training and external support. The present invention is operable to leave the legacy systems in tact means that existing staff can be retained, and can be trained in highly productive new tools, thereby reducing dependence on outside support and speeding implementation. This and the use of browsers also reduce training requirements.

Add Competitive Advantage. The ideal solution would NOT be throwaway work, but would retain value when the project is complete. The present invention actually adds lasting value to the legacy environment by adding a number of new features that add significant value. For example, competitive advantage is added by the acceleration in the velocity of information that can be made available from enterprise information stores. Further, the architecture of the solution offered by the present invention provides the opportunity to implement it remotely from the databases, so that it may be implemented using an ASP (Application Service Provider) business model, thereby even further reducing costs and increasing benefits.

Other Characteristics. The present invention offers other characteristics in various embodiments of the invention, many of which are more readily understood in the various embodiments described above.

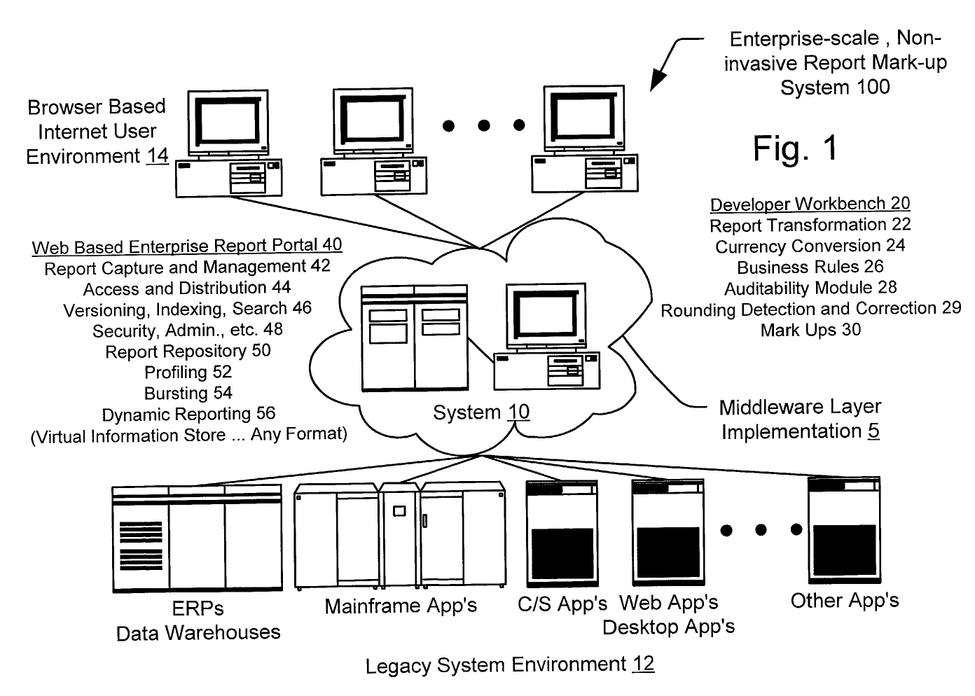

One aspect of the present invention is the realization that the optimal implementation of unique enterprise requirements for temporary transition phase requirements is to isolate them from the legacy and client environments. These functions and features described in detail below have been aggregated in a middleware layer, between the existing legacy system environment 12 and the Browser Based Internet User Environment 14 shown in FIG. 1.

FIG. 1 is a system diagram of a middleware layer implementation 5 built in accordance with the present invention. The middleware layer implementation 5 is operable to support and perform the temporary and unique requirements of the EURO Conversion Transition Period.

The term “middleware” in this case describes the fact that the application simply “snaps” into place between two layers, a legacy system environment 12 and a client environment 14, sometimes referred to as a browser based Internet user environment 14, without the need for a lot of custom interface code between unique applications or environments. Other network interfaces in addition to the Internet are also included within the scope and spirit of the invention. In one case, the invention utilizes a Microsoft NT based Web Application Server as its core platform to host the necessary functionality.

The present invention fully recognizes the massive investments made by enterprises in collecting, storing and managing data, and in providing it in the form of useful information to communities of users and individuals. The extraction of information from data and its timely and secure provision to individuals who have need to know is what gives data value in an enterprise. The Internet has accelerated the velocity of information, and has made it a competitive necessity to get information into the hands of knowledge workers whenever and wherever they need it. No other solution to this problem addresses this critical background requirement, and this is where the invention leaves lasting value behind after EURO is a reality. For example, the present invention is operable to perform relationship management within a company or enterprise to allow many users to share and use common information easily and cost-effectively.

The present invention recognizes that value is derived from data in enterprise applications principally in the form of reports. For example, databases provide value to an enterprise by providing information principally in the form of reports to users. Information can also be accessed from the database in the form or reports to be used as input to other systems as well. This feature supports interoperability and phased implementation of the various systems mentioned above.

This invention recognizes that development of custom interface software for unique hardware and software products and environments is costly and limits system flexibility. Instead of implementing a platform-dependent methodology, the invention instead relies on the use of standard report formats to capture data from a database. Legacy systems either have the necessary utilities, or they can be purchased for a modest cost, to allow the legacy systems to transfer files electronically using standard formats. In this way the invention is made platform independent, which helps enable it to scale from one to many platforms.

From one perspective, the functional operation of the present invention is described below. Files are transferred automatically on a scheduled basis from legacy systems into the Report Portal functionality. Legacy systems have their own report writers and administrators, who use them to create valuable information. Today, many such structured reports are still distributed on paper, and many large reports have difficulty being processed. The invention leverages some existing technology to capture these reports electronically, and then uses sophisticated techniques to manage the secure electronic distribution and storage of them to enterprise users with a need for the information.

This provides a platform to enable required EURO functionality without the need for invasive procedures. It has the effect of providing an e-business infrastructure platform that can stay in place and be extended beyond the EURO timeframe and application, while providing a competitive advantage by giving instantaneous information to users who have immediate need for it. Significantly, it obviates the need for renovation, restatement and reconciliation of databases and the need to overcome various limitations inherent in legacy construction that did not envision the need for EURO conversion. Examples include hard coding fields, values and tables as well as limitations in field structure, labeling, etc.

### Use of the Report Profile

The invention requires that a Report Profile be made for each report that is electronically captured, managed, distributed and stored. The term reports, as used herein, can also refer to screens that are representative of or reports and queries that initiate the generation of reports. Both of which are essentially structured real-time reports. Either of these reports can be profiled in various embodiments of the invention within departing from the scope and spirit thereof.

When a legacy application transfers a report file to the report portal, a report profile will be created. The profile is associated with a specific source report but operates independently of the data in a specific version of the report. In this way the report is executed according to the profile, independent of changes in data for that report. It is significant that every time thereafter that this report is run, the system will automatically look for its associated profile. The system matches the profile to its associated report and automatically executes the profile, without further human intervention in a “lights-out” enterprise manner. New reports require new profiles.

This profile typically deals with source and target report formats, which users will have access to the report, whether it is sent by email or in a complete attachment, security provisions, how many versions will be stored and for how long, who has change control over the report, and similar matters. However, the invention extends the Report Profiling process by recognizing that apart from the report object and related meta-data, there is actual live data in the report stream that can be captured and used for other purposes.

### Use of the Burster

The Burster is a powerful tool that essentially enables the user to break up any size report into pieces that can then be distributed or customized according to the specific needs of the business. It is analogous to what a person would do in separating pages from a paper report so that specific pieces can be given to specific individuals. The Burster does this electronically, and has the ability to implement many more sophisticated functions.

In one embodiment, the mark up functions used by the present invention are incorporated into the Burster. This allows access to the report's live data stream. However, this is not necessary in other embodiments, and other methods may be used as well by those skilled in the art. The system then calls on specific functionality created for this purpose to make the various changes needed to implement EURO functions on specific reports in the enterprise environment. In this way, it is possible to automate the generation of EURO data from legacy currency reports to be used by individuals and even systems that require EURO input data streams. Parsing using a Burster is a desirable functionality within certain embodiments of the present invention.

### Report Mark-up

For cases requiring currency conversion, and many other cases as well, the profile is adapted to grab the live data stream. It then uses special “mark-up” features to call specific functions that are required to convert a given source report in legacy currency into a target report with the necessary information in Euros. The mark-up features are implemented in intuitive graphical tools and drop-down menus. The system automatically generates script to execute the selected functionalities, although unique code can be written, if desired, by a capable user. Conversion macros for desktop systems are available and can be adapted for use in the present invention.

The profile allows the Administrator to select the desired target report format, so that the source report can be given additional functionalities such as export to Excel, creation of various filters, or use of PDF functionalities. All manner of unique EURO functionalities are provided, including conversion rates, source currency, target currency, rounding error detection and correction, various decimal selections and the like. Unique functionalities described later in this application include date-driven and source-driven criteria from the report to enable various special features. These features are significant in that they address the need to avoid ‘pollution’ of the database by providing safeguards that allow multiple currencies to co-exist.

Mark up functions include automation aides to speed the mark up of large reports. Numerous such aides will be apparent to those trained in the art, and they would include techniques to exclude certain rows, columns or cells before a general report conversion, or other techniques to replicate a step or function. Techniques to include automatic comments, tool tips or annotations, as well as hyperlinking to useful derived and related documents would also be helpful and are included within the scope and spirit of the invention. Mark up functions include drop down menus, graphical tools, and automatic generation of code. Mark up functionality is critical to the support of a phased implementation for Euro, where the invention creates EURO data in the report layer and uses it to feed another application that has been independently upgraded to Euro, perhaps by a vendor.

### User Presentation

The present invention is operable using any device that is operable to perform browsing of a network including the Internet, but alternative embodiments are envisioned that facilitate mark-ups of reports or screens for delivery to non-browser based environments. Using a browser means there are no client side plug-ins or unique training or support required for the client environment. Users need only know how to use a browser, and a host of formats are “browser friendly.” Plug-ins for unique formats can be implemented either on the server or on the browser.

Another standard feature of the current implementation is that it allows conversion from traditional formats such as ASCII or MFD, for example, to a proprietary format that allows single page serving and viewing of reports up to one million pages in total length. This format also allows introduction of features not found in source formats such as introduction of filters, export to Excel, and use of PDF features. Filters can help large reports aggregate data in reports in meaningful way, and features like indexing and search help users locate critical information in ways not supported by legacy systems. Conversions between formats are provided for increased user flexibility. A number of available platforms that are operable to provide these basic functions may be used for incorporation into the present invention.

As mentioned above, one embodiment of the present invention is shown in the FIG. 1. Further details of this embodiment are more fully described below. FIG. 1 is a system diagram of an enterprise-scale, non-invasive report mark-up system 100 built in accordance with the present invention. One aspect of the present invention resides in the Developer Workbench 20, but certain functionality can be embedded within another selected platform in various embodiments. The Report Portal Application 40 is a generic label for a series of required or desired functions that facilitate or enable the implementation of the invention; a number of rules based applications may be suitable platforms to host the invention.

The system 10 includes, among other things, a developer workbench 20 integrated with a report portal application 40, sometimes referred to as a web based enterprise report portal 40. The report portal application 40 captures a traditional financial report from a legacy system environment 12 and provides the report to the developer workbench 20. For example, an ASCII report expressed in legacy currency may be captured by the report portal application 40 from the legacy system environment 12 and provided to the developer workbench 20 in Microsoft WORD® or EXCEL® or some other useful format for conversion to EURO currency.

In one embodiment, the functionality of the developer workbench 20 includes at least four functional elements, though fewer or more functional elements are included in various embodiments of the invention. Examples of the functional elements include report transformation 22, currency conversion 24, programmable business rules 26 and an auditability and traceability module 28, as will be described more fully hereinafter. If desired, rounding detection 29 and mark-ups 30 are also offered as functional elements in the developer workbench 20 in various embodiments of the invention.

Analogously, the report portal application 40 includes at least five functional elements in one embodiment, though fewer or more functional elements are included in various embodiments of the invention. Examples of the functional elements include report capture and management 42 including format transformation (e.g., to Microsoft WORD®, EXCEL®, PDF or other formats), report access and distribution 44, report versioning, indexing and search 46, report security, administration, etc. 48 and report repository 50. If desired, profiling 52, bursting 54, and dynamic reporting 56 are also offered as functional elements in the report portal application 40 in various embodiments of the invention. From one perspective, the report portal application 40 is viewed as performing the function of a virtual information store in any number of desired formats.

In one embodiment, the Administrator is a special class of user of the report portal application 40 with unique privileges, such as sole read/write access to the developer workbench 20. There may be only one Administrator or there may be many Administrators, depending on the particular business enterprise and the reliance of its legacy system environment 12 on the changeover to the EURO currency. Alternatively, the desktop workbench 20 functionality may be provided to a designated operator responsible for report output for a given legacy system environment application, thereby placing the functionality of the desktop workbench 20 in the hands of the individual responsible for developing the report. In yet another alternative embodiment, any number of users may be provided with access to the functionality of the desktop workbench 20. However, in this alternative embodiment, the desktop workbench 20 is more tightly integrated with the report portal application 40 so that the users have access to the functional elements of the report portal application 40 necessary for the format transformation and publication of reports.

Alternatively, a report portal application 40 need not be utilized at all. In such case, however, certain functional elements must be added to the developer workbench 20. The essential elements that must be added to the desktop workbench 20 include a simplified report capture and management functionality and a simplified report format transformation functionality for capturing the traditional financial report and converting it to a more manageable and useful format, such as Microsoft WORD®, EXCEL®, PDF or other formats. The output from the desktop workbench 20 can then be stored in various media or output to a hard copy printer. Progressively, functionality may also be added to provide simplified report access and distribution of the captured, transformed and converted reports to other users. In certain simplified scenarios utilizing a middleware reporting layer, such as that illustrated in the FIG. 1, it may not be necessary to have report bursting or other complex functionality to perform the most basic non-invasive techniques for implementing the requirements of the EURO Conversion Transition Period.

Further details of many of the aspects of the developer workbench 20 built in accordance with the present invention as shown in the embodiment of the FIG. 1 are described below.

Developer Workbench 20. This term describes all of the Administrator functions, both those required to implement unique EURO functionalities as well as those underlying functionalities required to capture, manage, and store secure electronic reports from the legacy environment and distribute them across the internet to a browser based client set. The Administrator uses these features to profile reports, to implement the required markup functions, and to ensure the proper flow of information across the enterprise. Sub elements of the Developer Workbench broadly include the following:

Report Transformations 22. This refers generally to changes in report formats themselves that may include conversions to proprietary formats, or from one standard format to another to gain some advantage or features not available to the original source report or to the environment that produced it. Examples would be conversion to an Excel, Word, PDF or some other format to gain expanded flexibility for users.

Currency conversion 24. Currency conversions deal with the steps necessary to select the fields in a report that are to be converted and to effect this change. It includes accessing exchange rates from tables or remote sources such as web sites and applying the correct rates to specific data, using whatever business rules have been designed for the timeframe and transaction in process.

Business Rules 26. Business rules include the entire spectrum of rules prescribed by law such as Triangulation, no inverse conversion, rounding rules etc, as well as business rules selected by the enterprise or agreed between trading partners. For example, a business rule might be to add currency labels in converted currency fields.

Auditability module 28. Because in its full implementation, the source databases are not converted, currency records always match their audit documentation and the record of auditability is preserved. Changes occur within the system and each step of the profiling process is recorded as an audit log. Software is under configuration management, administrators are known, and each action is noted, including the business rules selected and employed.

Rounding Error Detection and Correction 29. Introduction of rounding errors during currency conversion are allowed under the rules, and occur inevitably. The invention provides an automated capability to detect certain rounding errors and to report them to users or administrators in the form of audit logs or annotations to the report.

Mark-ups 30. Mark-ups include a series of tools generally including exclusions, hyperlinks, annotations or comments, and a number of other options for currency conversions. In this case, annotations include any automatically generated or manually inserted comments into a report that concern the conversion or translation process. Hyperlinks are inserted as an aid to move a report or any information contained in a report to another location or to link to a derived report such as an audit log or rounding error report. Hyperlinks may be utilized to implement interoperability or phased implementations, as converted information in a target report may be hyperlinked to another application that requires such data as an input. Lastly, Currency Conversions are a class of Mark-up that is specifically detailed above, that deal with a myriad of issues in changing from legacy currency to Euro, or some other combination for the enterprise environment.

Further details of many of the aspects of the web based enterprise report portal 40 built in accordance with the present invention as shown in the embodiment of the FIG. 1 are described below. Again, using the Developer Workbench 20, it is envisioned that screens, queries or reports could be marked up and delivered to other environments that do not use browsers, yet are operable to receive such screens, queries or reports.

Web based Enterprise Report Portal 40. This is a general title that describes a set of functionalities that may exist in varying degrees, and that form the platform upon which EURO and other report conversion functionalities and non-invasive enterprise information access and distribution applications can be built. Other platforms that operate as rules engines and have sufficient scalability may be suitable as well. This is the functionality that remains in place after the EURO is the sole currency, enabling historical data access and enterprise reporting for all manner of applications. Included in these features are the following:

Report Capture and Management 42. This covers the process of capturing information in the form of reports that were originally created in a legacy system environment. It includes various processes required to manage the use of these source reports, and by extension, converted target reports for users or system interoperability.

Access and Distribution 44. Access is secured at the deepest levels of the operating system. Any authorized user can obtain access to the enterprise information he requires, whenever and wherever he requires it. In an alternative embodiment, there is no electronic distribution, but the converted reports are distributed in the manner in which the distribution that they are today, before the use of such an electronic delivery system.

Versioning, indexing, search 46. Capability is provided to retain versions of reports. Reports are indexed and robust search capabilities are included so that users may search reports or content to find exactly the information they require.

Security, administration, etc. 48. Depending upon the selection of platform for use in the present invention, a robust solution for providing user based and role-based security can be it provided. The current implementation of the invention utilizes NT as an operating system and therefore leverages this embedded organizational structure for security. Only users who have security authorization can receive reports using such systems.

Report Repository 50. The repository stores meta-data, which is data about the report traditionally used by reporting systems to manage the reports. It also includes the reports themselves, complete with companion audit log, annotations, etc. Either or both of the source report and the target report may be stored here, in whatever formats are selected. Or, for example, the source report may remain in the legacy environment if distribution is not needed, or to conserve storage space.

Profiling 52. Profiling has been described elsewhere in this application including “Use of the Report Profile” above.

Bursting 54. The operation of the burster has been described elsewhere in this application. This is one way to leverage the live data that is utilized by the burster to break up reports. The Burster may be used as a platform to implement various mark-ups within the reports. (See above)

Dynamic Reporting 56. Mark-ups can be implemented on traditional static reports, as well as on dynamic reports or queries using report templates where users can make queries and dynamic converted reports are obtained in near real time. The templates are profiled and when the dynamic report arrives in the system directory for processing, the profile is called and conversions are implemented from the profile to create the dynamic target report. In certain embodiments of the invention, these reports can be created using the Developer Workbench 20 and with or without browsers.

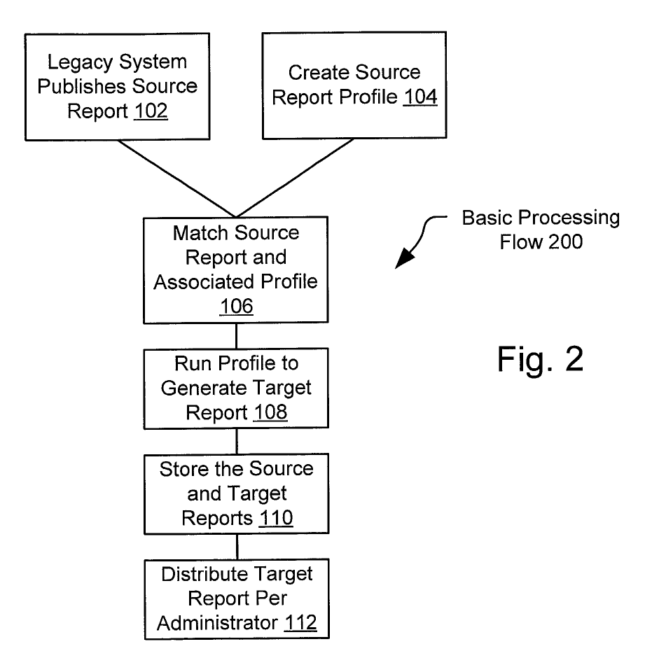

FIG. 2 is a functional block diagram illustrating an embodiment of a method 200 performed in accordance with the present invention. The method 200 includes the steps necessary to publish and capture a traditional financial report expressed in the legacy currency, sometimes referred to as the “source report,” and to transform and convert the Source report into a corresponding report expressed in the EURO currency, sometimes referred to as the “target Report.” As illustrated more specifically in the FIG. 2, the legacy system environment system 12 publishes the source report to the report portal application 40 or the web based enterprise report portal 40 (step 102). Using the desktop workbench 20, the Administrator profiles the source report, thereby creating a source report profile (step 104). The source report profile may be created in advance of the publication of the Source report or may created the first time that the Source report is published to the report portal application 40. Regardless, the source report profile preferably is created only once and is thereafter utilized in a “lights out” batch processing mode to automatically convert future versions of the same source report to a corresponding target report as previously described.

Once the source report profile has been created, the report portal application matches the source report profile to the source report (step 106) and runs the source report profile on the source report (step 108) to generate the target report. Thus, the target report is the EURO currency report that results from the conversion of the source report using the source report profile.

As mentioned above, this process is accomplished in a “lights out” manner without human intervention once the source report profile has been created for a particular source report. The report portal application 40 then stores the source report and the target report in the report repository 50 (step 110) and distributes the target report as specified by the Administrator (step 112). Of course, the source report is available to be distributed as well by the report portal application 40 as specified by the bursting profile established by the report access and distribution 44 functionality.

Other Aspects and Features of the Present Invention. Some or all of these features will be present depending upon embodiment and platform selection.

Non-Invasive to legacy systems and processes. This means that to get information out of legacy enterprise information stores, there is no need to modify the legacy databases, which can be particularly difficult in both old systems as well as more modem relational databases. This means that it does not matter if there is hard coding, limited field width, lack of labeling for currency or other reasons in the legacy data, since it is the data, not the underlying legacy programming, that is important to this solution.

User driven and controlled. The business manager can select the proper form and format of required information, as well as selected data, to form a new report derived from the underlying legacy-reporting environment. For example, depending upon the choice of platform, information can be gathered from multiple source reports/databases and consolidated in a single target Excel workbook, which can be further refined or enhanced, then published to the organization or individual members. Information from large reports can be served to an individual one page at a time to reduce bandwidth requirements.

Platform Independent Design. This aspect of the present invention offers a distinct advantage over traditional approaches. The solution is scalable across an enterprise and does not depend upon the hardware or software platforms from which information is accessed. This means that it can scale across platforms, from one to many, without the need for custom interface software modules. Virtually any enterprise data can be captured and converted using standard report formats from any underlying legacy environment.

Date Based Rules. Rules based conversions where DATE of record creation can be the rule. The system automatically can be programmed to use a set date or scan the report for a custom date to be selected. It is also possible for the system administrator to insert dates into specific legacy reports to support mark-up using aspects of the present invention. This date is used to identify the correct currency conversion rates to be used in particular data. In addition, multiple dates can be selected per a given report, allowing conversions at different exchange rates to be used on unique data sets within the same report or system.

a. The solution allows for mixed data to co-exist on same database as input to the solution, and to format the output correctly as desired, including the use of labels etc. An example would be for a database that has multiple currencies, whether it has labels or not. The target reports may be profiled to allow for a currency label or variable width field to be inserted, when the original report or database does not allow this.

b. Settings can be selected as a default or at the time of initial report profiling. These unique dates can be set for an organization, system, or report to ensure the correct rate is applied to all historical or current data.

c. Users may select the time of conversion of data to minimize business risk and disruption. For example, this may mean that one system may have a different cutover date than other systems, and the derived reports for that application may be treated independently. The ability to have mixed data able to co-exist on the database with safety allows for the separation of conversion from transition and migration, as described earlier in this document. This is yet another area where certain aspects of the present invention depart from tradition methods.

d. Use of this feature MAY avoid need for parallel bookkeeping through the transition year. You may use the same set of data and be assured the exchange rates are correct regardless of the date.

Source Based Rules. These are rules where the SOURCE of data can be the rule.

a. Source based rules are important where there are mixed currency sources (from multiple distributed applications). These can be presented in the required output format using the multiple tools provided.

b. Source base rules allow organizations to phase conversions of interoperating systems at different times. This means conversion can be one system at a time, or in any order. Converted data is known for example to be in EURO and may be provided to other applications that are interconnected and that require converted input in EURO.

c. These features allow users to set conversion dates with across internal and external enterprise boundaries without changes to underlying legacy applications.

Support for multiple distribution media. Output may be provided via electronic file, paper, screen or web based presentation.

Scalability. The solution is scalable from small businesses (NT PC based) to large enterprises (multiple NT server). Scalable performance means scalable investment.

Residual value. Unlike other solutions, it leaves behind value when currency conversion is over. It remains in place as a reporting platform for historical and other purposes. In addition, there is an existing support infrastructure in place and a product development roadmap.

Fast implementation. The system can be quickly deployed without the need for extensive external resources by training existing legacy system administrators.

Flexibility and control. Aggregation of all unique functionality in a central location for the enterprise means increased flexibility and control to implement changes. Software is under configuration management and all changes on individual reports are logged for trace ability.

Future Supportability. Uses only industry standard languages and products such as NT, VB, asp and XML to provide assurance of future supportability. Use of a platform is a unique approach to this problem, and use of a platform that is general purpose ensures ongoing development and support, yet adding even further value.

Interoperability. Capability is provided to enable systems to work with systems that may have been independently EURO-enabled, for example by vendors. Data from the converted reports from one system may be provided to other applications that required EURO input. Key supported techniques include XML, hyperlinks, annotations, and asp pages, depending upon the platform selected.

Elimination of Coding Errors. Because legacy systems are not renovated, there are no coding errors in the legacy system.

Maintenance of Auditability. Source data stays in the form of the support documentation. Coupled with no errors, this means that the audit trail is maintained. Conversions in the reporting environment maintain a log of actions and version of software utilized.

Detection and Correction of Rounding Errors. The solution includes capability to detect rounding errors as permitted by regulation, and to identify certain errors for correction by administrative personnel.

Post Processing Solution. Many current approaches add conversion functionality into existing legacy systems, increasing complexity and processing overhead. This solution offloads that functionality and output functions to improve performance and flexibility.

Dynamic Reporting. This system provides not only the ability to mark up static reports from structured materials, but also to perform mark ups on dynamic reports such as queries or screens. Typically templates are defined and profiled for dynamic query. The user selects a template, makes the appropriate query, then runs the report. The report enters the reporting system where the profile is matched and run, producing the converted EURO report for access by the user in near realtime.

Security. The system provides for user level and role based security, in the present case using and leveraging the NT security system and LDAP techniques. This means that the information is provided only to specific individuals who have a need to know, which is particularly important for Internet delivery systems.

PDF Forms. Some platforms provide a capability for applications that may have used many forms to provide applications such as customer billing. Instead of expensive archiving of forms, a capability is provided that allows separation of the forms from the data, so that the data can be stored in traditional files and a key will match it to a set of forms which are stored separately. In this manner, a Telco who has millions of bills using 50 different forms could significantly reduce storage by storing only the data. The system automatically knows that for a particular customer in a given month a certain form was used, and upon requests pulls the data and the form to provide to the customer. Storing 50 instances of the form is much more efficient that storing images of a million transactions.

Archiving Capability. This system has significantly reduced archiving capability since historical data stays in legacy currency and is converted on demand and not duplicated in converted form, thus requiring duplication of storage. In addition the electronic cataloging and indexing of reports and enterprise information means that it is much more efficient to retrieve materials. Historical data can be stored in optical media and immediately retrieved if it has been catalogued and indexed as described. Hence the system also provides archiving capability.

Proprietary formats and Format conversion. The present invention is able to leverage capabilities found in some platforms that includes a proprietary conversion process typically done on ASCII or MFD files. This enables very large reports up to 1 million pages to be efficiently served one page at a time upon demand, with acceptable performance even in a dial up environment. It also provides other very useful features like allowing filters to be embedded in reports to facilitate use and garnering of critical information. Using this format it is also able to profile an export of the report to Excel, or to use PDF forms capability. Excel workbooks may be created with pages from separate reports for example, which legacy systems do not typically support.

Report Mark Ups. As mentioned previously, mark up is another aspect of the present invention that obviates the need for renovation and invasive procedures in legacy database applications. Mark up enables users to extract information from databases in the form of reports, and to perform all manner of conversions and transformations on the report to make it suitable for users or other systems that may require different inputs.

From certain perspectives, one embodiment of the present invention is found in a system and method for implementing the temporary and unique requirements of the EURO Conversion Transition Period. The invention isolates the requirements of the Transition Period and implements them in a powerful middleware (as defined previously herein) reporting layer that is non-invasive to the existing legacy system environment. Underlying applications and databases remain in local currency, also referred to herein as legacy currency, thereby maintaining auditability and traceability, and eliminating the need for historical conversion and reconciliation of the data within the legacy system environment databases. Of course, the existing legacy system environment must still be modified to accommodate and process the EURO currency. However, the need to make massive, invasive changes to the underlying applications and existing databases, for example to provide six significant digits and to perform permissible rounding and triangulation, is substantially eliminated. Accordingly, changes to the legacy system environment applications and databases are simplified and minimized. The system and method of the present invention further includes means for automating the detection and correction of permitted rounding errors introduced by the changeover to the EURO.

As a result, the legacy system environment can continue to be used throughout the Transition Period without a noticeable effect on the processes. Standard, pre-defined reports may be generated in the same manner as before, while EURO reports derived from the pre-defined reports are created and distributed. And because IT directors and managers are forced to implement a Transition Period solution before their company's business requirements are fully ascertained, isolation of the temporary and unique requirements in a single middleware reporting application can also provide much needed flexibility and speed in reacting to new and changed requirements both during and following the Transition Period.

Furthermore, use of the non-invasive middleware-reporting layer of the invention supports re-engineering of applications and databases during implementation of the requirements of the EURO Conversion Transition Period by providing embedded functionality for widespread secure electronic access of standard reports to Internet/Intranet users. Thus, even when the EURO Conversion Transition Period is past, the invention will remain in the IT infrastructure to provide an extensible, multi-purpose platform for increasing e-commerce initiatives.

From other perspectives, the present invention is viewed as a system and a method that is operable to avoiding the introduction of massive, invasive procedures in the underlying legacy system environment applications, processes and existing databases where report transformation and financial conversions are required. More specifically in one particular application of the present invention, it possible to perform report transformation and currency conversion necessitated by the changeover to the EURO during the temporary and unique requirements of the EURO Conversion Transition Period. In the invention, the temporary and unique requirements associated with the EURO currency transactions are capable to be isolated in a middleware reporting layer so that the existing management reports are transformed and the currency conversion occurs within the middleware. This isolation eliminates the invasive techniques required to expand or modify existing database fields in the underlying legacy system environment applications.

The present invention utilizes existing management reports, which are transformed, converted and then re-published to the report repository for distribution to Internet/Intranet users in the traditional, secure environment. Both the original and converted reports are stored in the report repository. Accordingly, either report can be accessed and viewed in the desired currency. In addition, the invention provides the auditability and traceability that is essential when dealing with financial information. The approach of the invention leaves financial information, and in particular numerical figures, in the underlying database untouched, consistent with all backup documentation, so that complete auditability and traceability is maintained with data and documentation in original, unchanged form. Changes made in the middleware reporting layer are recorded in a robust external audit system including logs, comments and associated documentation.

Isolation of the temporary and unique requirements of the EURO Conversion Transition Period in the middleware reporting layer has compelling value propositions not found in any proposed, conventional, alternate solutions. These value propositions provided by the present invention include:

An entirely non-invasive approach to applications, processes and existing databases of the legacy system environment (assuming that the underlying system can accept the EURO as an alternate currency).

Complete and robust auditability and traceability with graphical tools, annotations and hyperlinks to source documents and reports.

Historical data restatement can be done in traditional reports expressed in the EURO currency, without manual restatement, reconciliation or use of parallel systems.

New and changed requirements can be easily and quickly implemented in one step, rather than by manual, separate re-coding steps in numerous applications.

Access to timely information and electronic reporting of financial documents can be implemented with substantial cost savings, thereby meeting the rapid response requirements necessitated by the continued emergence of e-commerce activities.

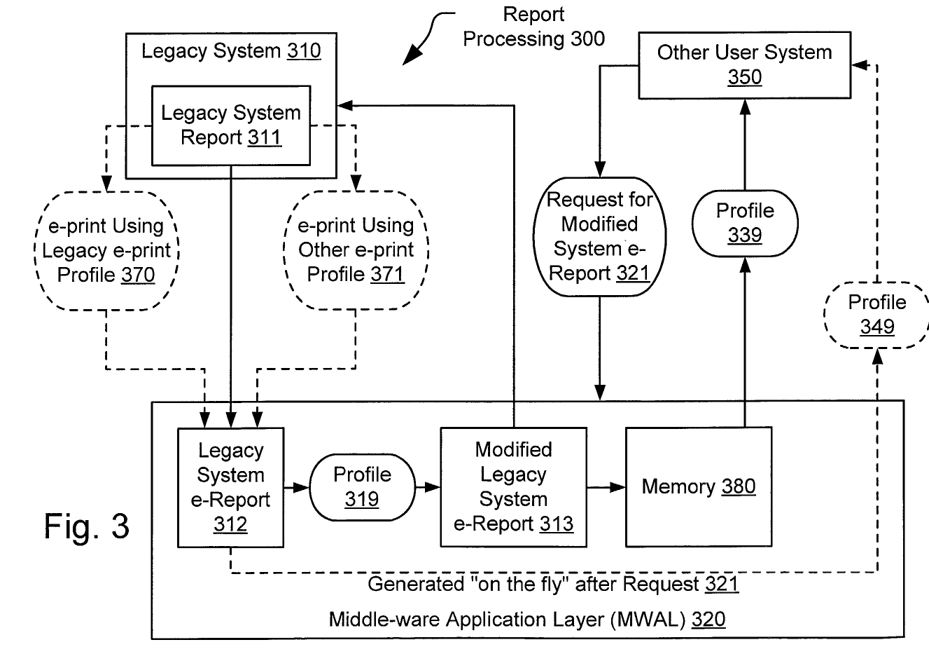

FIG. 3 is a system diagram illustrating an embodiment of report processing 300 performed in accordance with the present invention. A legacy system 310 is operable to generate a legacy system report 311. The legacy system report 311 is provided to a middle-ware application layer (MWAL) 320 in any number of ways. It is electronically printed (e-printed) directly over an existing network in one embodiment. The network is the Internet itself in certain embodiments of the invention. If desired, the e-printing is performed using any number of desired profiles that controls non-invasive mark-up of the legacy system report 311 itself during the e-printing from the legacy system 310 to the MWAL 320 over the network. The e-print of the legacy system report is performed using a legacy e-print profile as shown in the process block 370. Alternatively, the e-print of the legacy system report is performed using some other e-print profile as shown in the process block 371. A system administrator has the option to modify the legacy system report 311 to make it more “friendly” to the MWAL 320 for any subsequent mark-up processing. However, this application is not always necessary, as the MWAL 320 can nevertheless accommodate the legacy system report 311 in whichever format provided. However, the system administrator of the legacy system 310 is able to modify the legacy system report 311 itself or a legacy e-print profile that is used to govern the e-printing of the legacy system report 311 without compromising the functionality of the report processing 300.

Once the legacy system report 311 is e-printed to the MWAL 320, it is viewed as being a legacy system e-report 312 within the MWAL 320. Using a profile 319, the legacy system e-report 312 is marked-up to generate a modified legacy system e-report 313. From certain perspectives, the modified legacy system e-report 313 is viewed as being a virtual e-report that is a modification of the legacy system e-report 312 within the MWAL 320. If desired, the modified legacy system e-report 313 is automatically generated and transmitted back to the legacy system 310 over the network. Alternatively, the modified legacy system e-report 313 is stored in a memory 380 located within the MWAL 320.

The mark-up functionality and processing on the legacy system e-report 312 within the MWAL 320 includes any number of different processing as described above in various embodiments of the invention. In one embodiment, the processing includes performing currency conversion from the national currency used in the legacy system 310 and the legacy system report 311 to a different currency. This different currency is the new EURO currency used in much of Europe today. However, the present invention offers the functionality that the mark-up processing is capable to be performed on the legacy system e-report 312 without requiring any backward compatibility with the MWAL 320 itself. Different currencies can be used by any number of legacy systems without compromising the performance of the report processing 300. Other mark-up processing may be performed besides currency conversion as well. Any number of processing functions may be performed where conversion of some or all of the data used in legacy systems is desired to be transformed to a new standard. Moreover, the present invention is also operable to provide for those instances where different legacy systems are to be modified using different profiles.

Any other user system 350, having permission to do so, may access the modified legacy system e-report 313. From certain perspectives, the other user system 350 is another legacy system. However, the other user system is simply a user interface capable to access the MWAL 320 in other embodiments. Therefore, in some instances, the modified legacy system e-report 313 is viewed as being an e-report corresponding to the other user system 350 itself. As mentioned above, the MWAL 320 provides for the modified legacy system e-report 313 to be transmitted back to the legacy system 310 (or the other user system 350) immediately upon being generated. In embodiments where the modified legacy system e-report 313 is not sent back immediately, or after some period of time, the other user system 350 is able to request the modified legacy system e-report 313 as shown in a process block 321. This request is sent directly to the MWAL 320.

The modified legacy system e-report 313 is provided to the other user system 350 in any number of ways. For example, a report corresponding to the modified legacy system e-report 313 is actually generated “on the fly” in one embodiment as shown by the arrow 321. In such a situation, the legacy system e-report 312 is processed, at the time the request is made by the other user system 350. The report processing of the legacy system e-report 312 is performed in response to the request. In addition, a profile 349 is used to control the e-printing of this newly-generated report, generated from the legacy system e-report 312, as it is provided to the other user system. The profile 349 and the profile 319 are a similar profile, or a common profile in various embodiments of the invention; however, they are different profiles in others.

Alternatively, in embodiments where the modified legacy system e-report 313 is generated and stored in the memory 380, the request by the other user system 350 to the MWAL 320 initiates the transfer of the modified legacy system e-report 313, that is stored in the memory 380, to be transmitted to the other user system 350. Similarly, this transfer is performed using a profile 339. Also similarly, the profile 339 and the profile 319 are a similar profile, or a common profile in various embodiments of the invention; however, they are different profiles in others.

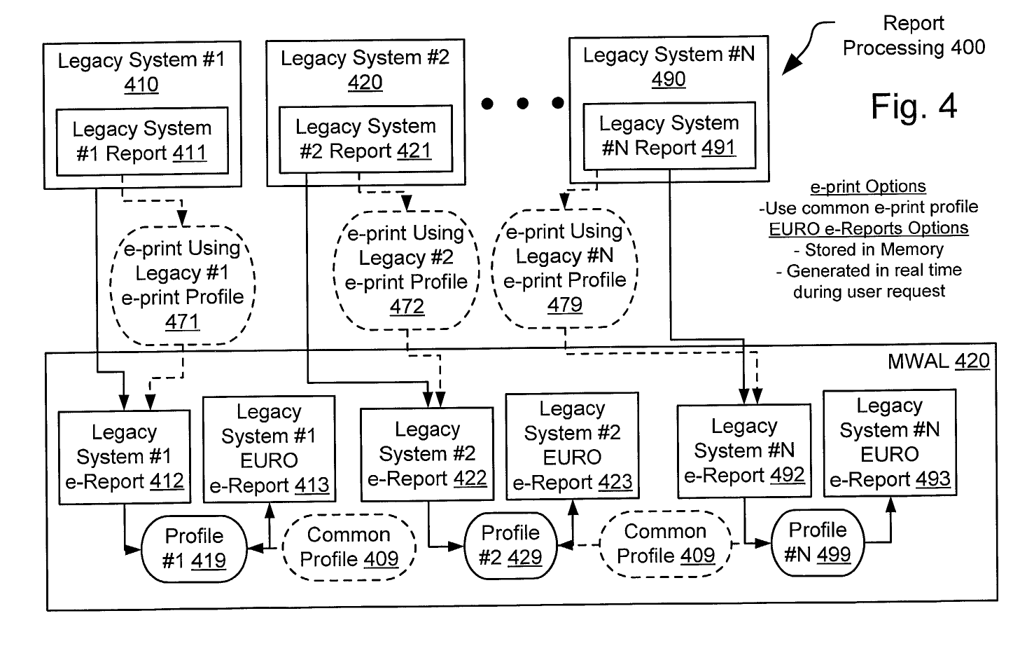

FIG. 4 is a system diagram illustrating another embodiment of report processing 400 performed in accordance with the present invention. A legacy system # 410 is operable to generate a legacy system #1 report 411. The legacy system #1 report 411 is provided to a middle-ware application layer (MWAL) 420 in any number of ways. It is electronically printed (e-printed) directly over an existing network in one embodiment. The network is the Internet itself in certain embodiments of the invention. If desired, the e-printing is performed using any number of desired profiles that controls non-invasive mark-up of the legacy system report # 411 itself during the e-printing from the legacy system # 410 to the MWAL 420 over the network. The e-print of the legacy system report is performed using a legacy #1 e-print profile as shown in the process block 471. A system administrator has the option to modify the legacy system #1 report 411 to make it more “friendly” to the MWAL 420 for any subsequent mark-up processing. However, this application is not always necessary, as the MWAL 420 can nevertheless accommodate the legacy system #1 report 411 in whichever format provided. However, the system administrator of the legacy system #1 410 is able to modify the legacy system #1 report 411 itself or a legacy e-print profile that is used to govern the e-printing of the legacy system #1 report 411 without compromising the functionality of the report processing 400.

Similarly, any number of other legacy systems, shown as legacy system #2 420, . . . , and legacy system #N 490 are each operable to generate legacy system reports, shown as legacy system #2 report 421, . . . , and legacy system #N report 491. The e-printing of these legacy system reports to the MWAL 420 is direct in some embodiments of the inventions, and it is performed using a legacy e-print profile, as shown by legacy #2 e-print profile, . . . , legacy #N e-print profile as shown in the process block s 472, . . . , and 479.

Once the legacy system #1 report 411 is e-printed to the MWAL 420, it is viewed as being a legacy system #1 e-report 412 within the MWAL 420. Using a profile #1 419, the legacy system #1 e-report 412 is marked-up to generate a modified legacy system #1 EURO e-report 413. From certain perspectives, the modified legacy system #1 EURO e-report 413 is viewed as being a virtual EURO e-report that is a modification of the legacy system #1 e-report 412 within the MWAL 420.

Similar to the functionality proffered by the various embodiments of the invention shown above, if desired, the modified legacy system #1 EURO e-report 413 is automatically generated and transmitted back to the legacy system 410 over the network. Alternatively, the modified legacy system #1 EURO e-report 413 is stored in a memory located within the MWAL 420. The accessing and retrieval of the modified legacy system #1 EURO e-report 413 is performed using any of the methods mentioned above, including retrieving it from memory or having it be generated “on the fly” in response to a request for a report representative of the legacy system #1 e-report 412.

In addition, each of the other legacy reports may undergo additional processing similar to the legacy system #1 e-report 412 using the profile #2 429, . . . , and the profile #N 499. If desired, the mark-up and report processing of the legacy system e-reports may be performed using a common profile 409 in some embodiments of the inventions. For example, the common profile 409 could be a default profile generated automatically by the system before a System Administrator adds unique Mark-Ups.

The report processing 400 is demonstrative of the capability of the present invention to accommodate any number of different legacy systems and perform mark-up processing on them using profiles that independently correspond to those legacy systems. However, the present invention is operable to perform report processing that is common to all of the legacy systems, such that control and flexibility are enhanced, unlike alternatives that require unique changes for each system.

As disclosed by the modified legacy system EURO e-reports 413, 423, . . . , and 493, the modification and mark-up processing of the legacy system e-reports 412, 422, . . . , and 492 includes currency conversion from any one or multiple national currencies corresponding to the legacy systems to the EURO. The present invention allows for the legacy systems to maintain their legacy system reporting using the national currencies without needing to dedicate and utilize processing resources on their end to perform this currency conversion processing. All processing envisioned by the present invention can be performed in the MWAL 420, typically on a NT or other suitable server. The present invention allows for an enterprise-scale implementation where any number of legacy systems may interface to the MWAL 420 to perform report processing that may include converting some of the data, reported in one format within the report, to a new format within another report.

From certain perspectives, the report processing shown above in the FIGS. 3 and 4 is performed on screens of the legacy system reports. Screens are really structured information that are real-time reports; they can be profiled and converted within the scope and spirit of this invention by numerous means. For example, when the legacy system report is provided, the report processing is performed at that time and in response to the data given at that particular point in time. The workbench would create a profile for each screen or query and run it when the completed request arrives from the database; it would then run the profile and return the transformed information back to the requester.

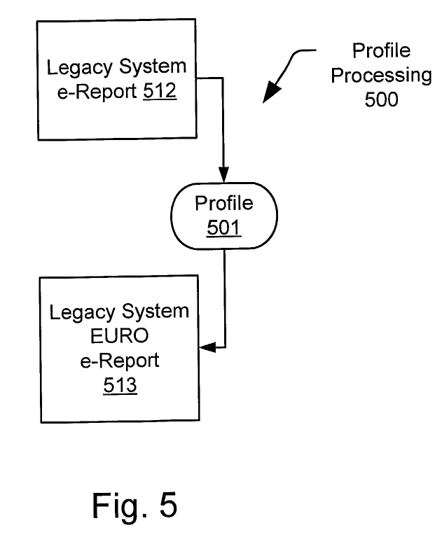

FIG. 5 is a system diagram illustrating an embodiment of profile processing 500 performed in accordance with the present invention. The profile processing 500 generically illustrates the transformation of a legacy system e-report 512 to a legacy system EURO e-report 513. The report processing shown in the FIG. 5 shows how the profile 501, that may be contained in a middle-ware application layer (MWAL), as shown in various embodiments of the invention, to control the mark-up and other processing performed within the profile processing 500 as determined by a system administrator. The legacy system EURO e-report 513 contains similar information as in the legacy system e-report 512 except that all of the currency information is converted from the currency standard in the legacy system e-report 512 to the EURO currency standard. The legacy system e-report 512 need not itself be in EURO currency format.

One aspect of the present invention provides for accommodation of the legacy system e-report 512 when it contains currency information that is already in EURO format. The profile processing 500 that employs the profile 501 is able to accommodate this situation and pass the EURO-based information unchanged in one legacy system (that is already operating using the EURO) and still accommodate the modification mark-up and other processing from a national currency to the EURO in another legacy system (that has not yet made the transition to the EURO). Use of rules and retaining the legacy System Administrator in the loop ensure that these mark-ups can be done effectively without error.

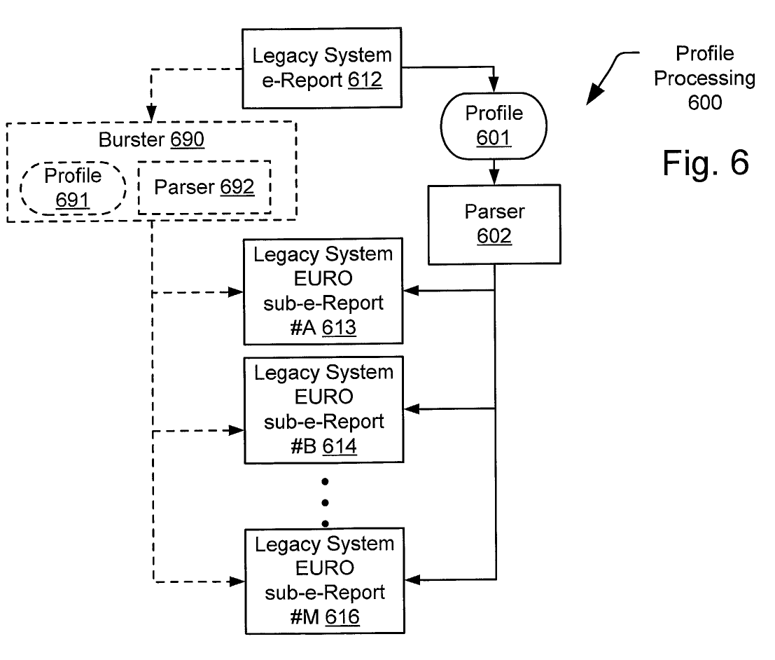

FIG. 6 is a system diagram illustrating another embodiment of profile processing 600 performed in accordance with the present invention. The profile processing 600 is a variation of the profile processing 500 shown above in the FIG. 5. The profile processing 600 illustrates the transformation of a legacy system e-report 612 to a number of legacy system EURO sub-e-reports, as shown by a legacy system EURO sub-e-report #A 613, a legacy system EURO sub-e-report #B 614, . . . , and a legacy system EURO sub-e-report #M 616; this illustrates, for example, how a Burster may parse and create separate reports, which in some embodiments may have unique profiles.

A profile 601 is used to control the mark-up and report processing of the legacy system e-report 612 into the legacy system EURO sub-e-reports 613, 614, . . . , and 616. A parser 602 is used to sub-divide certain portions of the legacy system e-report 612 into the legacy system EURO sub-e-reports 613, 614, . . . , and 616. The legacy system EURO sub-e-reports 613, 614, . . . , and 616 are each similar in size and content fields in one embodiment, and they are independent and different in other embodiments.

Alternatively, a burster 690 is employed to perform the transformation of the legacy system e-report 612 to a number of legacy system EURO sub-e-reports, as shown by the legacy system EURO sub-e-report #A 613, the legacy system EURO sub-e-report #B 614, . . . , and the legacy system EURO sub-e-report #M 616. The burster 690 is operable to contain a profile 691 and a parser 692 in certain embodiments of the invention. Here, a separate module, that is external to a report processing system in one embodiment, and integrated within the report processing system in another embodiment, is used to perform both the control of the mark-up and report processing on the legacy system e-report 612 as well as the parsing of the legacy system e-report 612 into the legacy system EURO sub-e-reports 613, 614, . . . , and 616.

The FIG. 6 is illustrative of some of the variations by which the legacy system e-report 612 is transformed into the legacy system EURO sub-e-reports 613, 614, . . . , and 616. Clearly, other manners of performing the transformation are also envisioned without departing from the scope and spirit of the invention.

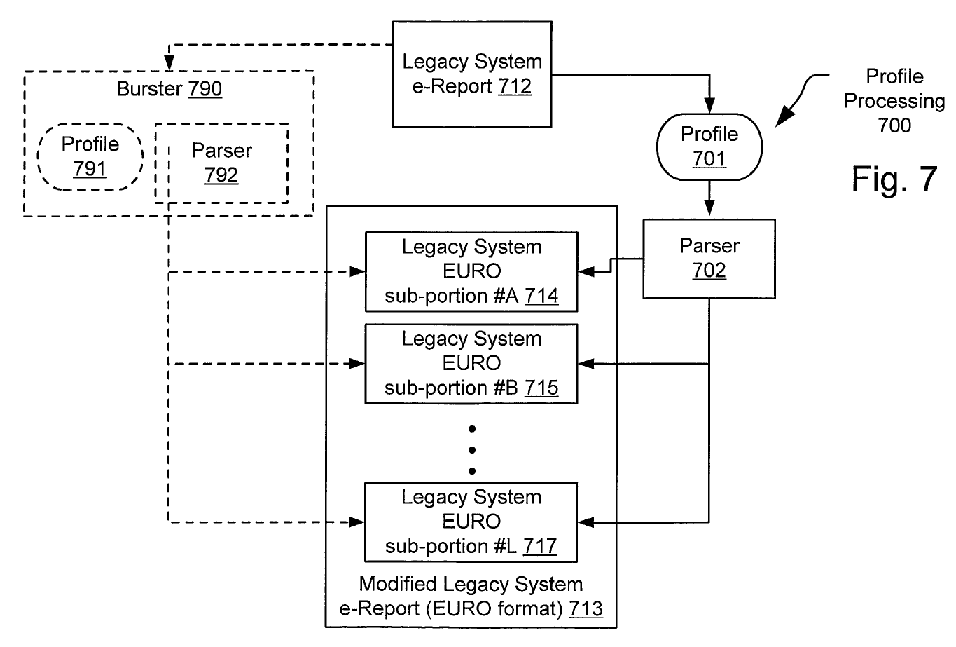

FIG. 7 is a system diagram illustrating another embodiment of profile processing 700 performed in accordance with the present invention. The profile processing 700 is another variation of the profile processing 500 shown above in the FIG. 5.

The profile processing 700 illustrates the transformation of a legacy system e-report 712 to a modified legacy system e-report (in EURO format) 713. The modified legacy system e-report (in EURO format) 713 has an indefinite number of sub-portions, shown as a legacy system EURO sub-portion #A 714, a legacy system EURO sub-portion #B 715, . . . , and a legacy system EURO sub-portion #L 717. A profile 701 is used to control the mark-up and report processing of the legacy system e-report 712 into the modified legacy system e-report (in EURO format) 713 having the various sub-portions 714, 715, . . . , and 717. A parser 702 is also operable to subdivide certain portions of the legacy system e-report 712 into the various portions 714, 715, . . . , and 717. The sub-portions 714, 715, . . . , and 717 are each similar in size and content fields in one embodiment, and they are independent and different in other embodiments.

Alternatively, a burster 790 is employed to perform the transformation of the legacy system e-report 712 to the modified legacy system e-report (in EURO format) 713 having the indefinite number of sub-portions, shown as a legacy system EURO sub-portion #A 714, a legacy system EURO sub-portion #B 715, . . . , and a legacy system EURO sub-portion #L 717. The burster 790 is operable to contain a profile 791 and a parser 792 in certain embodiments of the invention. Here, a separate module, that is external to a report processing system in one embodiment, and integrated within the report processing system in another embodiment, is used to perform both the control of the mark-up and report processing on the legacy system e-report 712 as well as the parsing of the legacy system e-report 712 into the modified legacy system e-report (in EURO format) 713 having the various sub-portions 714, 715, . . . , and 717.

The FIG. 7 is illustrative of some of the variations by which the legacy system e-report 712 is transformed into the modified legacy system e-report (in EURO format) 713 having the various sub-portions 714, 715, . . . , and 717. Clearly, other manners of performing the transformation are also envisioned without departing from the scope and spirit of the invention.

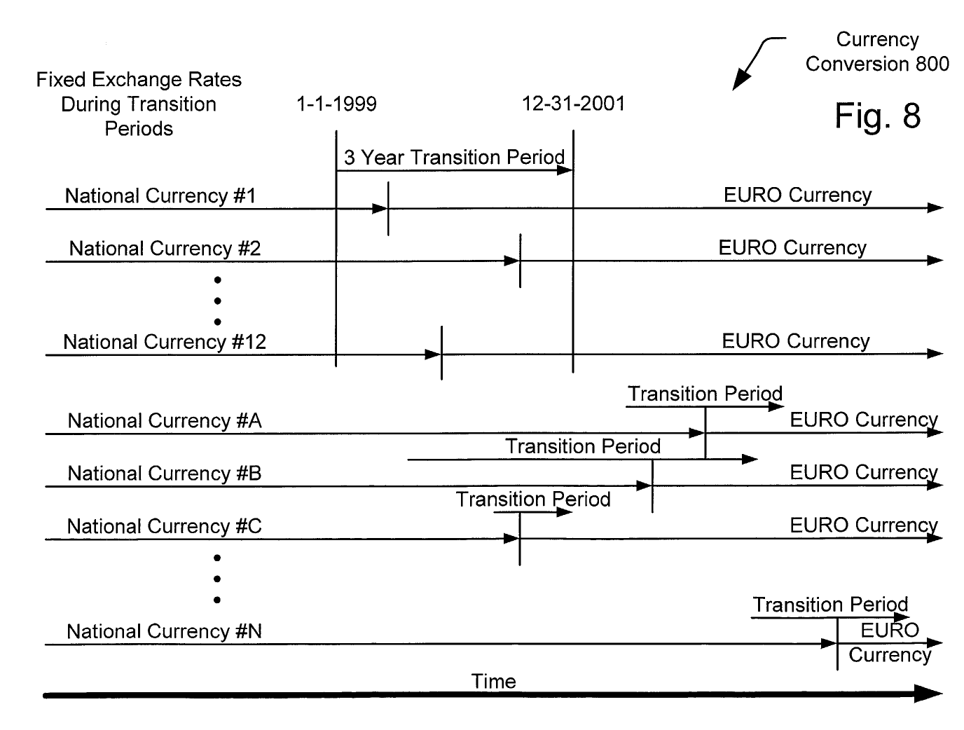

FIG. 8 is a timeline diagram illustrating an embodiment of currency conversion 800 that is capable to be performed in accordance with the present invention. A number of national currencies, shown as a national currency #1, national currency #2, . . . , and national currency #12 as well as a national currency #A, national currency #B, . . . , and national currency #N are each undergoing or will undergo a transition from their respective national currency to the EURO currency. A group of the twelve countries, shown as the national currencies 1, 2, . . . , and 12, undergoes transition from their respective national currencies to the EURO currency during a three year transition period extending from Jan. 1, 1999 to Dec. 31, 2001. There is a fixed exchange rate guaranteed for each of the countries during the transition period. The exchange rate for each of the national currencies 1-12 is guaranteed during that three year period.

Certain other of the other national currencies A, B, C, . . . , and N perform the transition during the same three year period as the national currencies 1, 2, . . . , and 12. For example, the national currency C has a one year transition period on the tail end of the three year transition period. The transition period of the various national currencies 1, 2, . . . , and 12 are of various lengths. For example, the transition period of the national currency #B is shown to have a transition period that is relatively longer than the transition period of the national currency #A. As shown by the national currencies #A and #N, the transition periods are capable to extend after the three year transition period has expired. The present invention allows for any number of additional national currencies to transition to the EURO at any time. The present invention also allows for the addition of any number of countries to come into the fold of EURO currency using countries at any time after the three year transition period has expired, as exemplified by the national currencies #A and #N. The length of the transition periods of these national currencies and the exchange rates of these transitions are also variable. The present invention is equally operable to perform transformation from other currencies to a common currency as well.

In view of the above detailed description of the present invention and associated drawings, other modifications and variations will now become apparent to those skilled in the art. It should also be apparent that such other modifications and variations may be effected without departing from the spirit and scope of the present invention.

What is claimed is:

1. An enterprise-scale non-invasive financial report mark-up processing system, the system comprising:
a legacy system that is operable to generate structured legacy system information having a format and having financial data corresponding to a first currency standard;
a middle-ware application layer, communicatively coupled to the legacy system, that is operable to receive the legacy system report from the legacy system via electronic printing thereby generating a legacy system e-report; and
wherein the middle-ware application layer employs a profile to perform mark-up processing on selected portions of the legacy system e-report to generate a modified legacy system e-report; and
the modified source e-report comprising financial data corresponding to a second currency standard.

2. The system of claim 1, wherein the second currency standard comprises a EURO currency.

3. The system of claim 1, wherein the middle-ware application layer further comprises a burster; and the
the burster comprises the profile.

4. The system of claim 3, wherein the burster is operable to parse the legacy system e-report into at least one of a plurality of sub-e-reports and a plurality of sub-portions.

5. The system of claim 1, further comprising:
at least one additional legacy system that is operable to generate at least one additional legacy system report having at least one additional format and having financial data corresponding to a third currency standard;
the middle-ware application layer is also communicatively coupled to the at least one additional legacy system and is operable to receive the at least one additional legacy system report from the at least one additional legacy system via electronic printing thereby generating at least one additional legacy system e-report; and
wherein the middle-ware application layer employs at least one additional profile to perform mark-up processing on selected portions of the at least one additional legacy system e-report to generate at least one additional modified legacy system e-report; and
the modified source e-report comprising financial data corresponding to a fourth currency standard.

6. The system of claim 5, wherein the profile and the at least one additional profile are substantially a common profile.

7. The system of claim 5, wherein the second currency standard and the fourth currency standard both comprise a common currency standard.

8. The system of claim 1, wherein modified legacy system e-report is generated during a predetermined transition period from the first currency standard to the second currency standard.

9. An enterprise-scale non-invasive financial report mark-up processing system, the system comprising:
a legacy system that is operable to generate a source report having financial information based on a national currency;
a middle-ware application layer, communicatively coupled to the legacy system, that is operable to receive an electronically printed version of the source report and perform non-invasive mark-up processing of the financial information based on the national currency within the source report and to convert that financial information to financial information based on the EURO thereby generating a target report; and
a user system, communicatively coupled to the middle-ware application layer, that is operable to retrieve the target report from the middle-ware application layer.

10. The system of claim 9, wherein at least one of the communicative coupling between the legacy system and the middle-ware application layer and the communicative coupling between the middle-ware application layer and the user system comprises communicative coupling via the Internet.

11. The system of claim 9, wherein the electronically printed version of the source report is generated based on an e-print profile.

12. The system of claim 9, wherein the non-invasive mark-up processing is performed using a profile;
the profile comprises a plurality of processing rules;
and the profile is contained within the middle-ware application layer.

13. The system of claim 9, wherein the middle-ware application layer distributes the target to at least one additional user system.

14. The system of claim 9, wherein the middle-ware application layer distributes the target to the user system after the user system transmits a request to the middle-ware application layer.

15. The system of claim 9, wherein the middle-ware application layer further comprises a burster; and the
the burster comprises a profile.

16. A method to perform non-invasive financial report mark-up processing, the method comprising:
creating a source report profile to be used to process a source report, the source report having financial data corresponding to a first currency standard;
electronically transmitting the source report to a middle-ware application layer;
processing the source report within the middle-ware application layer to generate a target report based on the report profile; and
generating a modified source report, the modified source report having financial data corresponding to a second currency standard.

17. The method of claim 16, wherein the second currency standard comprises a EURO currency.

18. The method of claim 16, wherein the target report is generated in response to a request provided by a user system.

19. The method of claim 16, wherein the target report comprises a plurality of sub-portions.

20. The method of claim 16, wherein the target report is parsed into a plurality of sub-e-reports.
